(19) United States
(12) Patent Application Publication
(10) Pub. No.: US 2026/0091480 A1
(43) Pub. Date: Apr. 2, 2026

(54) WORK STAND FOR SAW MACHINE

(71) Applicant: Chin-Chin Chang, Taichung City (TW)

(72) Inventor: Chin-Chin Chang, Taichung City (TW)

(21) Appl. No.: 18/903,113

(22) Filed: Oct. 1, 2024

(51) Int. Cl. B25H 1/00

(52) U.S. Cl. CPC B25H 1/0042

(57) ABSTRACT

A work stand has a plate, a supporting frame, and an adapting unit. The plate has a main body, at least one first assembling hole, at least one second assembling hole, and an opening. The at least one first assembling hole and the at least one second assembling hole are defined through the main body. The opening is defined through the main body. The supporting frame is connected to the main body. The adapting unit has a sheet and at least one assembling hole. The sheet is detachably mounted to the main body and covering the opening. The at least one assembling hole is defined through the sheet, is elongated, and communicates with the opening. The adapting unit with the assembling hole being elongated can be detachably assembled to the plate for assembly of saw machines of various specifications.

### BACKGROUND OF THE INVENTION

### 1. Field of the Invention

The present invention relates to a work stand, and more particularly to a work stand for mounting a saw machine.

### 2. Description of Related Art

A saw machine is a tool configured to cut objects by a blade, such as a miter saw, a circular saw, and a table saw. Wherein, the miter saw is commonly assembled to a work stand to cut objects.

A conventional work stand has a plate and a frame. The plate is where the miter saw is assembled to. The frame is connected beneath the plate to support the plate. In the conventional work stand, the plate has multiple assembling holes for assembling the miter saw. The miter saw has multiple mounting holes correspondingly. Multiple bolts are respectively mounted through the multiple mounting holes of the miter saw and the multiple assembling holes of the plate for connection of the miter saw and the conventional work stand.

Consequently, positions of the multiple assembling holes are arranged corresponding to positions of the multiple mounting holes of the miter saw. However, the positions of the multiple assembling holes are fixed, stationary, and cannot suit miter saws of various specifications.

To overcome the shortcomings of the conventional work stand, the present invention provides a work stand for a saw machine to mitigate or obviate the aforementioned problems.

### SUMMARY OF THE INVENTION

The main objective of the present invention is to provide a work stand that can be applied to saw machines of various specifications.

The work stand has a plate, a supporting frame, and an adapting unit. The plate has a main body, at least one first assembling hole, at least one second assembling hole, and an opening. The at least one first assembling hole and the at least one second assembling hole are defined through the main body. The opening is defined through the main body. The supporting frame is connected to the main body. The adapting unit has a sheet and at least one assembling hole. The sheet is detachably mounted to the main body and covers the opening. The at least one assembling hole is defined through the sheet, is elongated, and communicates with the opening. The adapting unit with said assembling hole being elongated can be detachably assembled to the plate for assembly of saw machines of various specifications.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a work stand in accordance with the present invention;

FIG. 2 is a partially exploded perspective view of the work stand in FIG. 1;

FIG. 3 is an enlarged perspective view of the work stand in FIG. 1 showing a saw machine assembled thereto;

FIG. 4 is a partially exploded perspective view of the work stand in FIG. 1;

FIG. 5 is a partially enlarged perspective view of the work stand in FIG. 1;

FIG. 6 is another partially enlarged perspective view of the work stand in FIG. 1;

FIG. 7 is an enlarged side view of the work stand in FIG. 1;

FIG. 8 is an enlarged side view in partial section of the work stand in FIG. 1 across line 8-8;

FIG. 9 is another enlarged side view of the work stand in FIG. 1 and shows an adapting unit being adjusted;

FIG. 10 is still another enlarged side view in partial section of the work stand in FIG. 1;

FIG. 11 is yet another enlarged side view in partial section of the work stand in FIG. 1;

FIG. 12 is a partially top view of the work stand in FIG. 1 and shows the saw machine mounted thereto;

FIG. 13 is another partially top view of the work stand in FIG. 1 and shows another saw machine mounted thereto; and

FIG. 14 is still another partially top view of the work stand in FIG. 1 and shows still another saw machine mounted thereto.

### DETAILED DESCRIPTION OF PREFERRED EMBODIMENTS

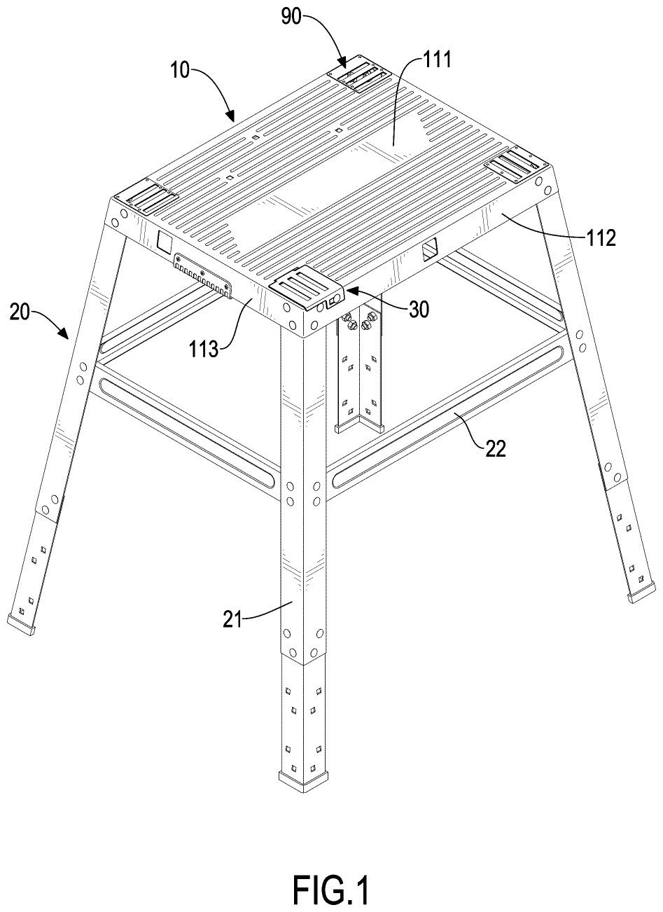

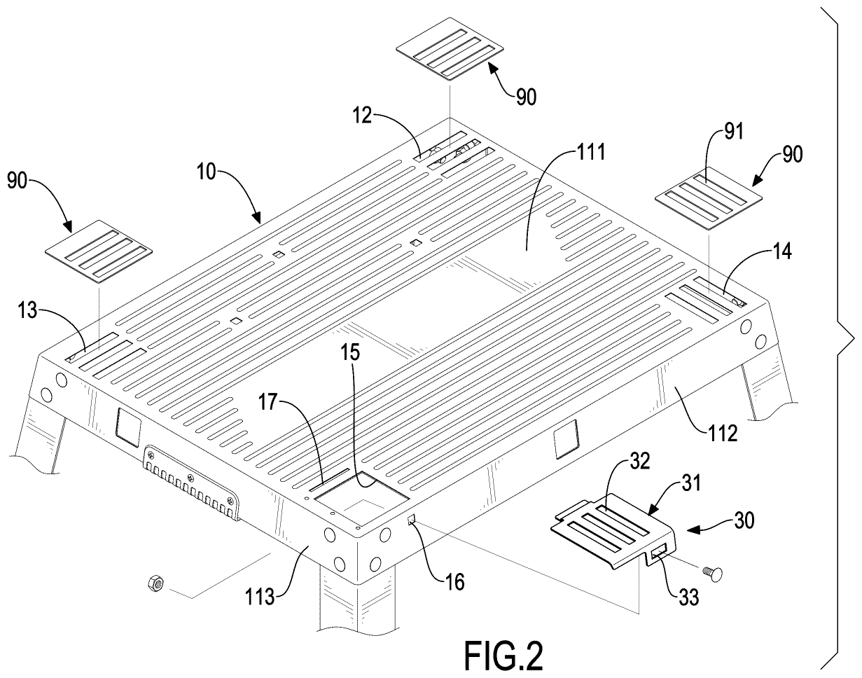

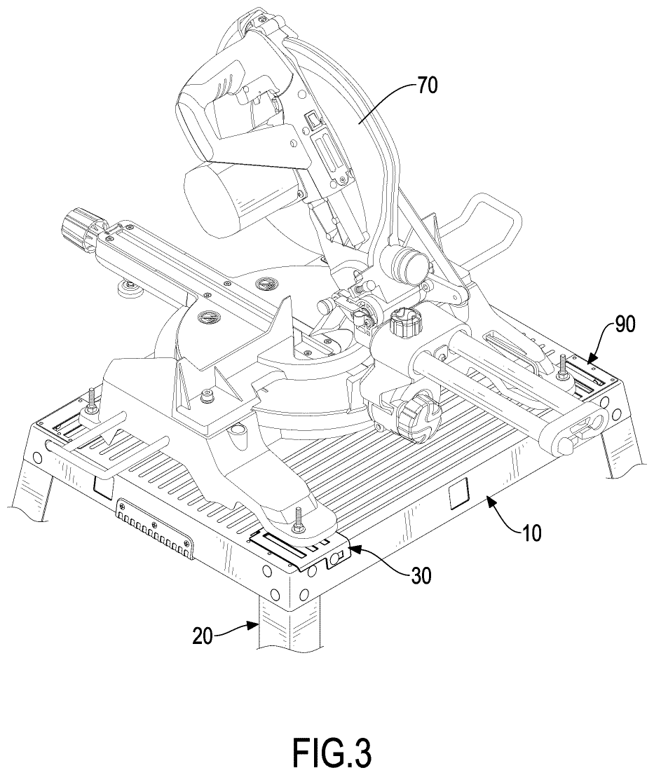

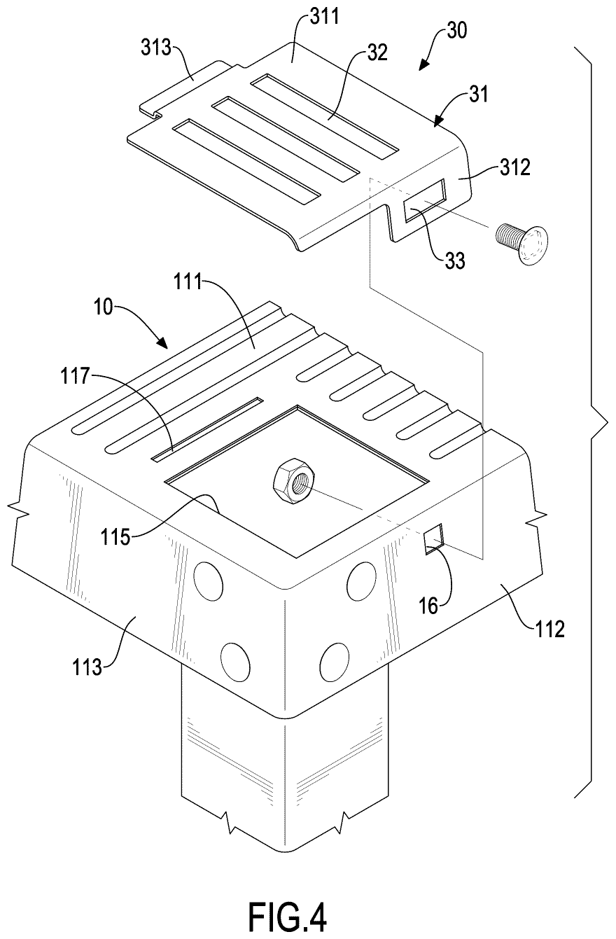

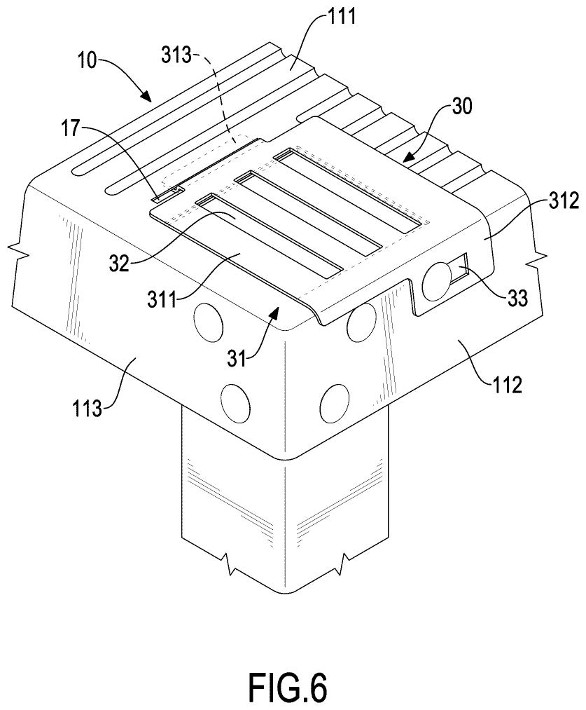

With reference to FIGS. 1 to 6, a work stand in accordance with the present invention is configured for a saw machine 70 such as a miter saw to be mounted thereon. The work stand has a plate 10, a supporting frame 20, and an adapting unit 30.

With reference to FIGS. 1 to 6, the plate 10 has a main body 111, two lateral flanges 112, two end flanges 113, three first assembling holes 12, three second assembling holes 13, three third assembling holes 14, an opening 15, an mounting hole 16, and a guiding slit 17.

With reference to FIGS. 1 to 6, the main body 111 is rectangular and has four corners. The two lateral flanges 112 are opposite in position and are parallel to each other. The two end flanges 113 are opposite in position and are parallel to each other. In the embodiment of the present invention, each lateral flange 112 is longer than each end flange 113.

With reference to FIGS. 1 to 6, each one of the first assembling holes 12 is an elongated hole and is defined through the main body 111 of the plate 10. The first assembling holes 12 are located at one of the four corners and are parallel to one another. Each one of the second assembling holes 13 is an elongated hole and is defined through the main body 111 of the plate 10 as well. The second assembling holes 13 are located at another one of the four corners and are parallel to one another. In the embodiment of the present invention, the first assembling holes 12 and the second assembling holes 13 are located adjacent to the same one of the two lateral flanges 112 and are parallel to each one of the two lateral flanges 112.

With reference to FIGS. 1 to 6, each one of the third assembling holes 14 is an elongated hole and is defined through the main body 111 of the plate 10. The third assembling holes 14 are located at still another one of the four corners and are parallel to one another. In the embodiment of the present invention, an extending direction of each one of the third assembling holes 14 is perpendicular to an extending direction of each one of the first assembling holes 12 and is perpendicular to an extending direction of each one of the second assembling holes 13.

With reference to FIGS. 1 to 6, the opening 15 is located at the remaining one of the four corners. In the embodiment of the present invention, the opening 15 has an outline being rectangular.

With reference to FIGS. 1 to 6, the mounting hole 16 is defined through one of the flanges 111, 112 of the main body 111 and located adjacent to the opening 15. In the embodiment of the present invention, the mounting hole 16 is defined through one of the lateral flanges 112.

With reference to FIGS. 1 to 6, the guiding slit 17 is defined through the main body 111, located adjacent to the opening 15 and opposite to the mounting hole 16.

With reference to FIGS. 1 to 6, the supporting frame 20 is configured to support the work stand on the ground. The supporting frame 20 has four legs 21 and four beams 22. The four legs 21 are respectively disposed at the four corners and are assembled to the lateral flanges 112 and the end flanges 113 of the plate 10. Each adjacent two legs 21 are connected together by one of the four beams 22.

With reference to FIGS. 1 to 6, the adapting unit 30 has a sheet 31, three assembling holes 32, and an elongated mounting hole 33. The sheet 31 has a major section 311, a mounting portion 312, and an engaging portion 313. The mounting portion 312 extends from the major section 311 of the sheet 31. An obtuse angle is defined between the major section 311 and the mounting portion 312. The engaging portion 313 is configured to be inserted in the guiding slit 17 of the plate 10. The engaging portion 313 extends from the major section 311 and is located opposite to the mounting portion 312.

With reference to FIGS. 1 to 6, each one of the three assembling holes 32 is defined through the major section 311 of the sheet 31. The three assembling holes 32 located at the major section 311 are parallel to one another. The elongated mounting hole 33 is defined through the mounting portion 312 and extends parallel to the guiding slit 17 of the plate 10.

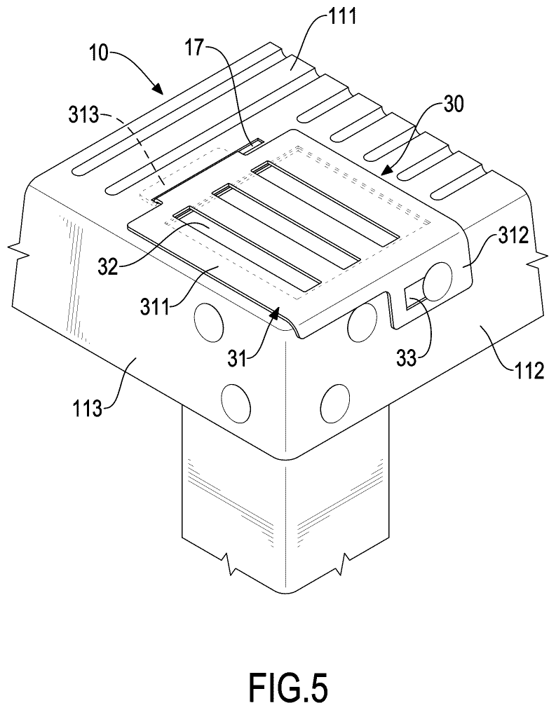

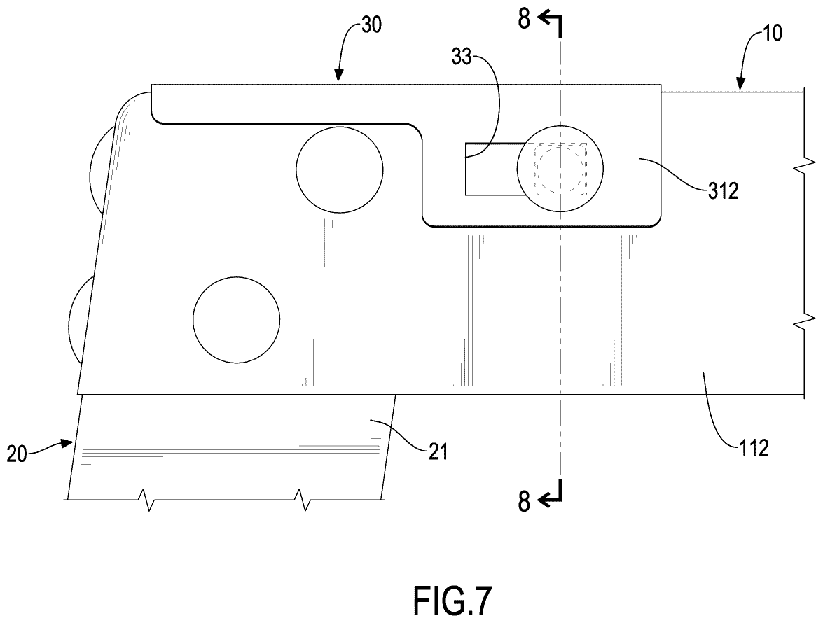

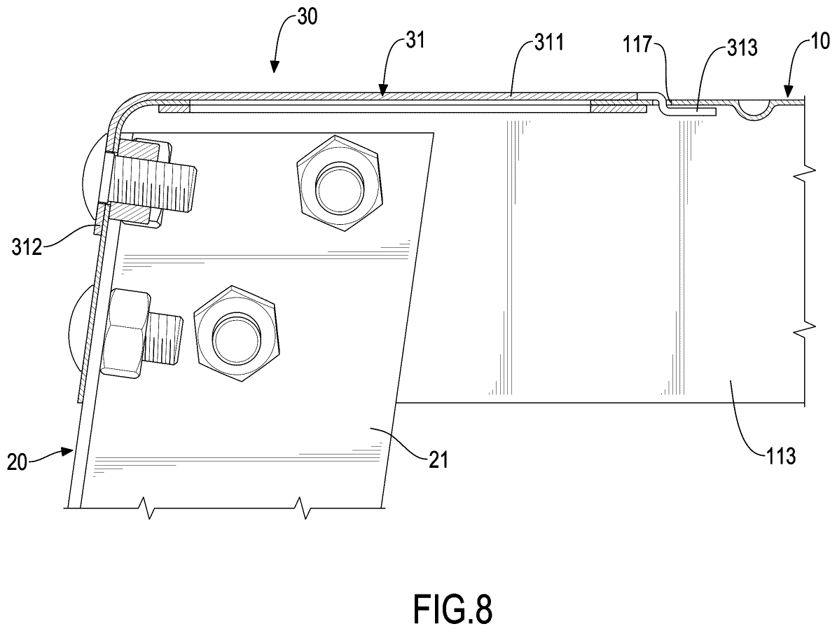

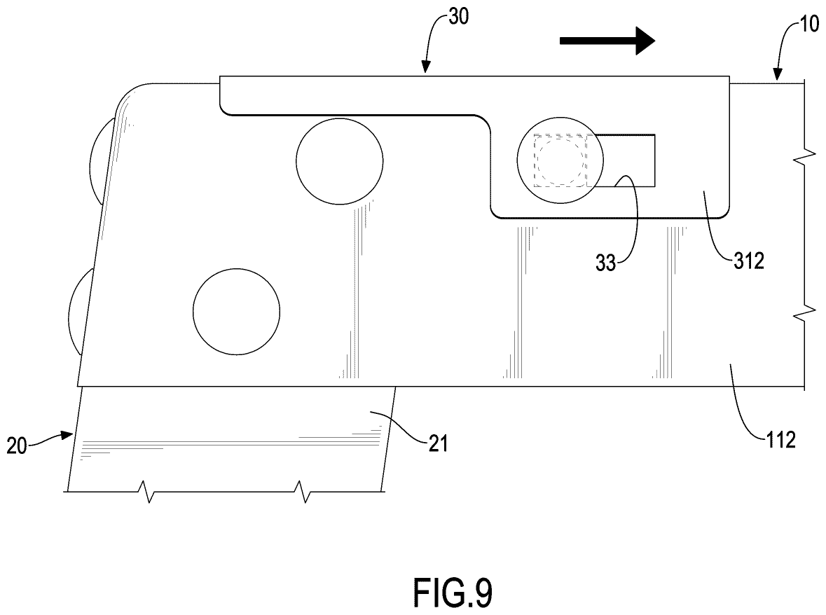

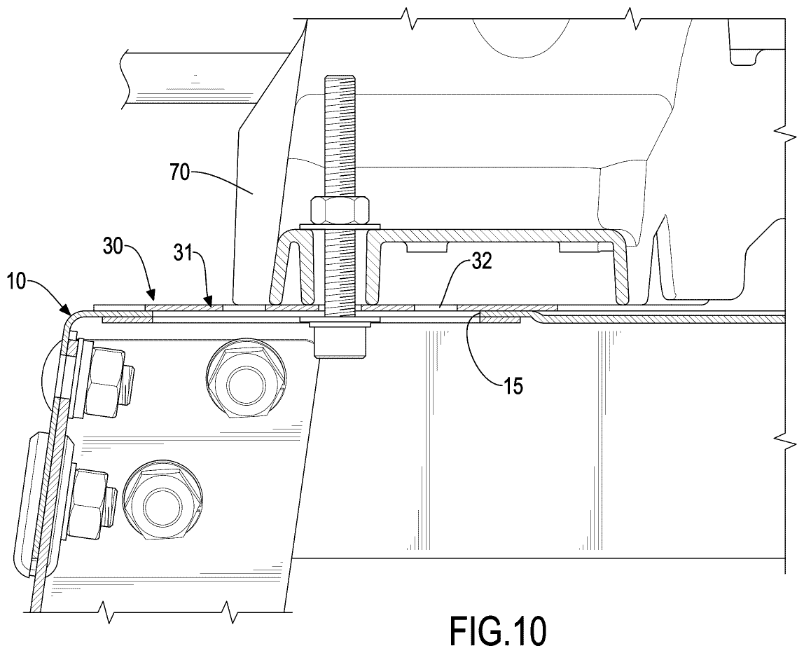

With reference to FIGS. 5 to 10, the engaging portion 313 of the sheet 31 of the adapting unit 30 is inserted in the guiding slit 17 of the plate 10, and a bolt is mounted through the elongated mounting hole 33 of the adapting unit 30 and the mounting hole 16 of the plate 10 to connect the adapting unit 30 and the plate 10. Wherein, the engaging portion 313 is movable along the guiding slit 17 when the adapting unit 30 moves relative to the plate 10. In the embodiment of the present invention, each one of the three assembling holes 32 is parallel to each one of the third assembling holes 14.

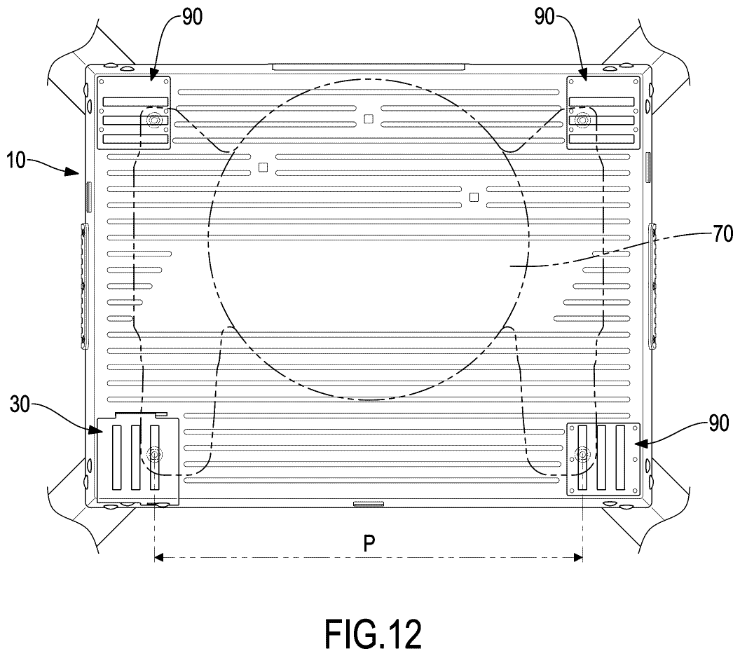

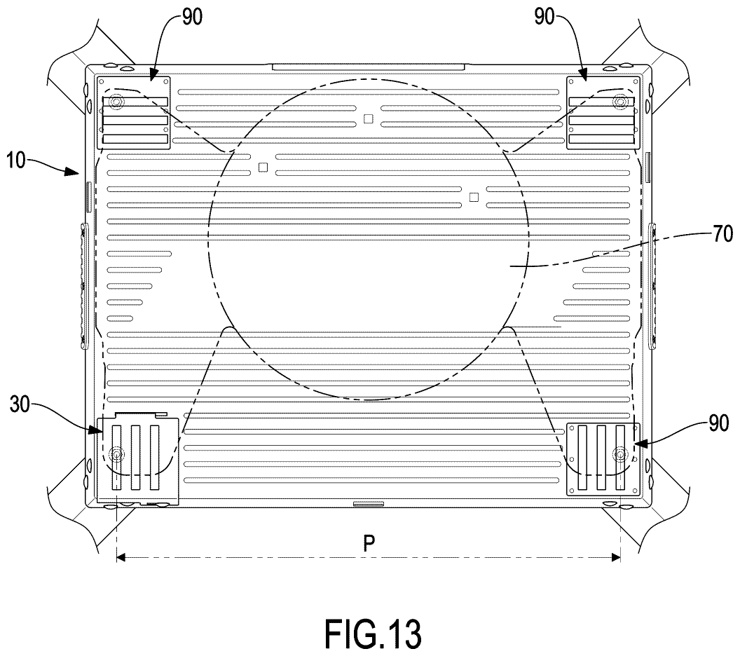

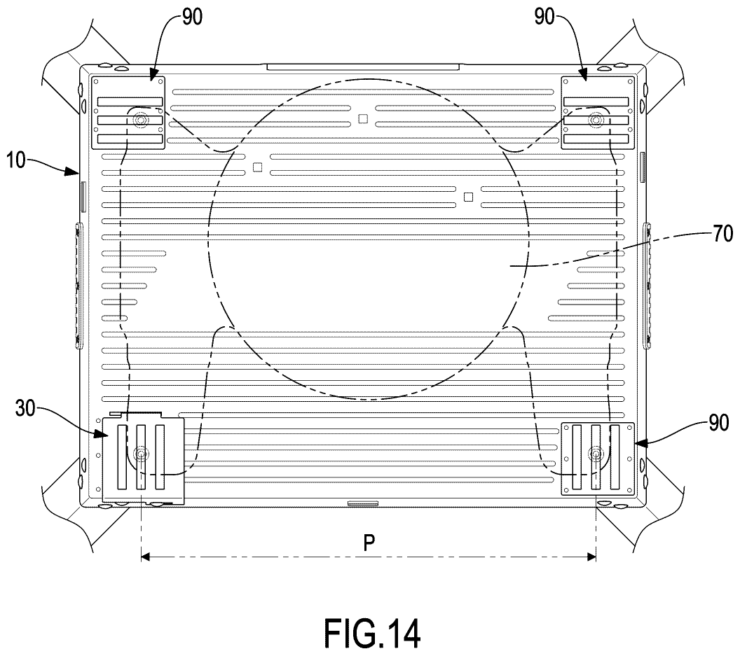

With reference to FIGS. 12 to 14, with the elongated first assembling holes 12, second assembling holes 13, third assembling holes 14 of the plate 10, and the elongated assembling holes 32 of the adapting unit 30, a position where the saw machine 70 is assembled can be adjusted.

When a pitch P between mounting holes of the saw machine 70 varies with specifications, with the guiding slit 17 of the plate 10 and the elongated mounting hole 33 of the adapting unit 30, the adapting unit 30 can be moved relative to the plate 10 along the guiding slit 17 to correspond to the varied pitch P. Therefore, the work stand of the present invention is suitable for saw machines of various specifications and a scope of application of the present invention is further expanded.

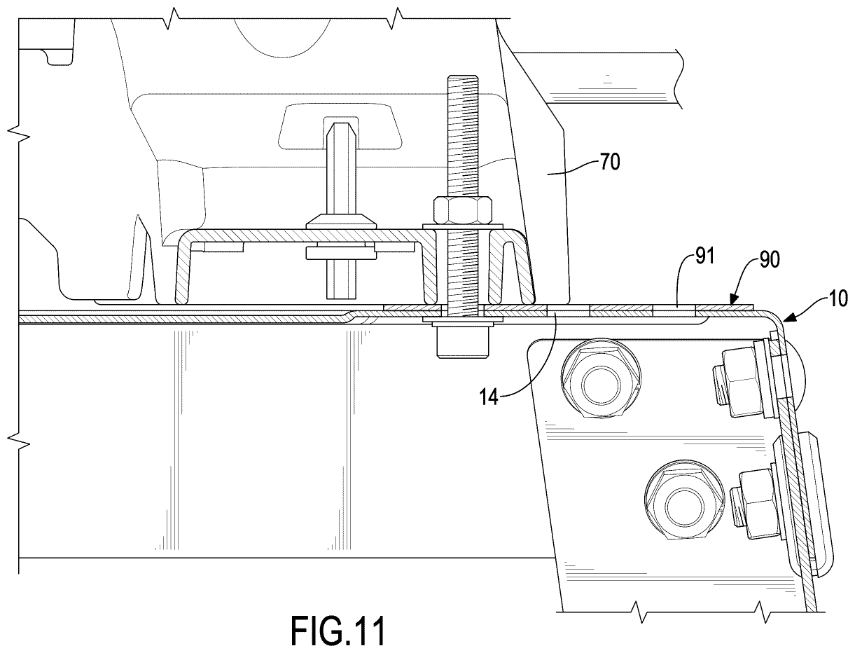

Furthermore, with reference to FIGS. 1, 2, 3, and 11, the work stand of the present invention may further have three rectangular washers 90 arranged between the saw machine 70 and the plate 10. Each one of the three rectangular washers 90 has three through holes 91. Each one of the three through holes 91 is elongated. The three through holes 91 of each one of the three rectangular washers 90 are parallel to one another and arranged according to the first assembling holes 12, the second assembling holes 13, or the third assembling holes 14. The three rectangular washers 90 may be respectively deployed at three of the four corners of the plate 10. The through holes 91 of each one of the three rectangular washers 90 are respectively aligned with and communicate with the first assembling holes 12, the second assembling holes 13, or the third assembling holes 14.

In the embodiment of the present invention, the rectangular washers 90 between the saw machine 70 and the plate 10 make the saw machine 70 assembled to the plate 10 levelly.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A work stand comprising:
a plate having
a main body;
at least one first assembling hole defined through the main body;
at least one second assembling hole defined through the main body; and
an opening defined through the main body;
a supporting frame connected to the main body;
an adapting unit having
a sheet detachably mounted to the main body and covering the opening; and
at least one assembling hole defined through the sheet, being elongated, and communicating with the opening.

2. The work stand as claimed in claim 1, wherein the sheet has
a major section where the at least one assembling hole is located;
a mounting portion extending from the major section, and an obtuse angle defined between the major section and the mounting portion; and
the adapting unit has an elongated mounting hole defined through the mounting portion.

3. The work stand as claimed in claim 2, wherein
the plate has a guiding slit defined through the main body, disposed adjacent to the opening, and extending parallel to the elongated mounting hole; and
the adapting unit has an engaging portion extending from the major section, opposite to the mounting portion in position, inserted in the guiding slit, and movable along the guiding slit.

4. The work stand as claimed in claim 3, wherein the plate has at least one third assembling hole defined through the main body.

5. The work stand as claimed in claim 4, wherein
the at least one first assembling hole includes a plurality of first assembling holes;
the at least one second assembling hole includes a plurality of second assembling holes; and
the at least one third assembling hole includes a plurality of third assembling holes.

6. The work stand as claimed in claim 1, wherein
the plate has a guiding slit defined through the main body, disposed adjacent to the opening; and
the adapting unit has
a major section where the at least one assembling hole is located; and
an engaging portion extending from the major section, inserted in the guiding slit, and movable along the guiding slit.

7. The work stand as claimed in claim 1, wherein
the plate is rectangular and has four corners;
the at least one first assembling hole is located at one of the four corners;
the at least one second assembling hole is located at another one of the four corners; and
the opening is located at still another one of the four corners.

8. The work stand as claimed in claim 2, wherein
the plate is rectangular and has four corners;
the at least one first assembling hole is located at one of the four corners;
the at least one second assembling hole is located at another one of the four corners; and
the opening is located at still another one of the four corners.

9. The work stand as claimed in claim 3, wherein
the plate is rectangular and has four corners;
the at least one first assembling hole is located at one of the four corners;
the at least one second assembling hole is located at another one of the four corners; and
the opening is located at still another one of the four corners.

10. The work stand as claimed in claim 4, wherein
the plate is rectangular and has four corners;
the at least one first assembling hole is located at one of the four corners;
the at least one second assembling hole is located at another one of the four corners;
the opening is located at still another one of the four corners; and
the at least one third assembling hole is located at a remaining one of the four corners.

11. The work stand as claimed in claim 5, wherein
the plate is rectangular and has four corners;
the plurality of first assembling holes are located at one of the four corners;
the plurality of second assembling holes are located at another one of the four corners;
the opening is disposed at still another one of the four corners; and
the plurality of third assembling holes are disposed at a remaining one of the four corners.

12. The work stand as claimed in claim 6, wherein
the plate is rectangular and has four corners;
the at least one first assembling hole is located at one of the four corners;
the at least one second assembling hole is located at another one of the four corners; and
the opening is located at still another one of the four corners.

13. The work stand as claimed in claim 1, wherein
the supporting frame has
four beams; and
four legs assembled to the plate, each adjacent two of the legs connected together by one of the four beams.

14. The work stand as claimed in claim 2, wherein
the supporting frame has
four beams; and
four legs assembled to the plate, each adjacent two legs connected together by one of the four beams.

15. The work stand as claimed in claim 3, wherein
the supporting frame has
four beams; and
four legs assembled to the plate, each adjacent two legs connected together by one of the four beams.

16. The work stand as claimed in claim 4, wherein
the supporting frame has
four beams; and
four legs assembled to the plate, each adjacent two legs connected together by one of the four beams.

17. The work stand as claimed in claim 5, wherein
the supporting frame has
four beams; and
four legs assembled to the plate, each adjacent two legs connected together by one of the four beams.

18. The work stand as claimed in claim 6, wherein
the supporting frame has
four beams; and
four legs assembled to the plate, each adjacent two legs connected together by one of the four beams.

19. The work stand as claimed in claim 10, wherein
the work stand has three rectangular washers respectively deployed at three of the four corners of the plate;
each one of the three rectangular washers has at least one through hole, each one of the at least one through hole being elongated; and
the at least one through hole of each one of the three rectangular washers are respectively aligned with and communicate with the at least one first assembling holes, the at least one second assembling hole, or the at least one third assembling hole.

20. The work stand as claimed in claim 11, wherein
the work stand has three rectangular washers respectively deployed at three of the four corners of the plate;
each one of the three rectangular washers has a plurality of through holes, each one of the plurality of through holes being elongated; and
the plurality of through holes of each one of the three rectangular washers are respectively aligned with and communicate with the plurality of first assembling holes, the plurality of second assembling holes, or the plurality of third assembling holes.
